(19) United States
(12) Patent Application Publication
(10) Pub. No.: US 2015/0193129 A1
(43) Pub. Date: Jul. 9, 2015

(54) METHOD FOR EXECUTING APPLICATION AND ELECTRONIC APPARATUS

(71) Applicant: Samsung Electronics Co., Ltd., Suwon-si (KR)

(72) Inventors: An-Ki CHO, Suwon-si (KR); Jae-Wook LEE, Suwon-si (KR); Sun-Geun KIM, Busan (KR)

(21) Appl. No.: 14/590,416

(22) Filed: Jan. 6, 2015

Related U.S. Application Data
(60) Provisional application No. 61/924,564, filed on Jan. 7, 2014.

(30) Foreign Application Priority Data
Apr. 2, 2014 (KR) 10-2014-0039502

(51) Int. Cl. G06F 3/0484; G06F 3/0483; G06F 3/0482

(52) U.S. Cl. CPC G06F 3/04842; G06F 3/0482; G06F 3/0483

(57) ABSTRACT

An electronic device is provided. The device includes a touch-sensitive display, and a processor configured to display a screen of a first application program, on the display, wherein the processor is configured to display a first portion that is able to receive a user input and is movable, on the display, receive a user input applied on or near the first portion displayed on the display, and display a second portion that is larger than the first portion, on the display, in response to the user input, and wherein the second portion includes at least one item for enabling a user to select at least one function of the first application program.

### CROSS-REFERENCE TO RELATED APPLICATION(S)

This application claims the benefit under 35 U.S.C. §119(e) of a US Provisional application filed on Jan. 7, 2014 in the U.S. Patent and Trademark Office and assigned Ser. No. 61/924,564, and under 35 U.S.C. §119(a) of a Korean patent application filed on Apr. 2, 2014 in the Korean Intellectual Property Office and assigned Serial number 10-2014-039502, the entire disclosure of each of which is hereby incorporated by reference.

### TECHNICAL FIELD

The present disclosure relates to an electronic device of executing (or operating) an application and a method thereof. More particularly, the present disclosure relates to a method and apparatus for providing a function related to an application.

### BACKGROUND

An electronic device provides various applications, such as a clock, a calendar, a memo note, a search window, a map, news, and a real-time camera, as well as a mobile communication function, so that a user can use these functions using the electronic device.

Also, the electronic device can provide screens of various applications, and each application may update a screen at regular time intervals or perform predetermined operation in response to an input from a user.

Since applications operate based on independent processes, in order to transmit data or execute an interaction function between different processes, applications may use appropriate interfaces according to a method defined in an Operating System (OS) to communicate with each other. Accordingly, in a server/client structure or in a structure in which several applications share functions, in order to update a function, all applications linked to the function may be updated.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method of providing a function related to an application when the application is executed.

In accordance with an aspect of the present disclosure, an electronic device is provided. The device includes a touch-sensitive display, and a processor configured to display a screen of a first application program on the display, wherein the processor is configured to display a first portion that is able to receive a user input and is movable, on the display, receive a user input applied on or near the first portion displayed on the display, and display a second portion that is larger than the first portion, on the display, in response to the user input, and wherein the second portion includes at least one item for enabling a user to select at least one function of the first application program.

In accordance with another aspect of the present disclosure, a method is provided. The method includes displaying a screen of a first application program on a touch-sensitive display of an electronic device, receiving a user input that is applied on or near the first portion displayed on the display, and displaying a second portion on the display that is larger than the first portion in response to the user input, wherein the second portion includes at least one item for enabling a user to select at least one function of the first application program.

In accordance with another aspect of the present disclosure, an electronic device is provided. The device includes a display, a memory, and a processor electrically connected to the display and the memory, wherein the processor is configured to display a first screen on the display, search for database including information about at least one function of a first application, in the memory, display a portion including at least one item for enabling a user to select the at least one function, in at least one area of the display, based on at least one part of the information, to receive a user input that is applied on or near the portion, and to execute the at least one function of the first application, in response to the user input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment including an electronic device according to various embodiments of the present disclosure;

FIG. 2 is a block diagram illustrating an application executing module of an electronic device according to various embodiments of the present disclosure;

FIGS. 3A, 3B, 3C and 3D are views for describing an application execution method according to various embodiments of the present disclosure;

FIG. 4 is a flowchart illustrating an application execution method according to various embodiments of the present disclosure;

FIGS. 5A, 5B, 5C, 6A, 6B, 6C, 7A, 7B, 7C, 8A, 8B, 8C, 9A, and 9B are views for describing application execution methods of an electronic device according to various embodiments of the present disclosure;

FIGS. 10A, 10B, 11A, 11B, 12A, 12B, 13A, and 13B are views for describing application execution methods in a multi-window environment according to various embodiments of the present disclosure;

FIGS. 14 and 15 are flowcharts illustrating application execution methods according to various embodiments of the present disclosure;

FIG. 16 illustrates a configuration of database according to various embodiments of the present disclosure;

FIGS. 17A, 17B, and 17C are views for describing operations of a server and electronic devices according to various embodiments of the present disclosure; and

FIG. 18 is a block diagram of an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “or” includes any and all combinations of one or more of the associated listed items. For example, “A or B” may include A, B, or both A and B.

It will be understood that, although the terms first, second, etc. may be used herein to describe various components, these components should not be limited by these terms. For example, the terms do not limit the order and/or importance of the components. These terms are only used to distinguish one component from another. For example, a first user device and a second user device that are user devices indicate different user devices. For example, a first component could be termed a second component, and, similarly, a second component could be termed a first component, without departing from the scope of the present disclosure.

It will be understood that when a component is referred to as being “connected” or “coupled” to another component, it can be directly connected or coupled to the other component or intervening components may be present. In contrast, when a component is referred to as being “directly connected” or “directly coupled” to another component, there are no intervening components present.

The terminology used herein is for the purpose of describing particular embodiments only and is not intended to be limiting of the present disclosure

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An electronic device according to various embodiments of the present disclosure may be a device with communication capabilities. For example, the electronic device may be at least one of (i.e., any one or a partial or whole combination of) a smart phone, a tablet Personal Computer (PC), a mobile phone, a video phone, an electronic-Book (e-Book) reader, a desktop PC, a laptop PC, a netbook computer, a Personal Digital Assistant (PDA), a Portable Multimedia Player (PMP), a digital audio player, mobile medical equipment, a camera, or a wearable device (for example, a Head-Mounted-Device (HMD) such as electronic glasses, electronic clothes, an electronic bracelet, an electronic necklace, an electronic accessory, an electronic tattoo, or a smart watch).

According to some embodiments, the electronic device may be a smart home appliance with a communication capacity. The smart home appliance may be at least one of a TeleVision (TV), a Digital Versatile Disk (DVD) player, audio equipment, a refrigerator, an air conditioner, a cleaner, an oven, a microwave, a washing machine, an air cleaner, a set-top box, a TV box (for example, Samsung HomeSync™, Apple TV™, Google TV™, or the like), game consoles, an electronic dictionary, a camcorder, or an electronic album.

According to some embodiments, the electronic device may be at least one of various medical equipment (for example, Magnetic Resonance Angiography (MRA), Magnetic Resonance Imaging (MRI), Computed Tomography (CT), a medical camcorder, ultrasonic equipment, and the like), a navigation device, a Global Positioning System (GPS) receiver, an Event Data Recorder (EDR), a Flight Data Recorder (FDR), an automotive infotainment device, electronic equipment for a ship (for example, marine navigation device, gyro compass, and the like), avionics, security equipment, a head unit for vehicle, an industrial or home robot, an Automatic Teller Machine (ATM) of bank, or a Point of Sales (PoS) of store.

According to some embodiments, the electronic device may be at least one of furniture or part of building/structure with communication capabilities, an electronic board, an electronic signature receiving device, a projector, or various metering equipment (for example, water, electricity, gas, or waves metering equipment). The electronic device may be one or a combination of one or more of the aforementioned devices. Also, the electronic device may be a flexible device. It will be apparent to those of ordinary skill in the art that the electronic device according to various embodiments of the present disclosure is not limited to the aforementioned devices.

Hereinafter, an electronic device according to various embodiments of the present disclosure will be described with reference to the appended drawings. In the following description, the term “user” may indicate a person or an apparatus (for example, an intelligent electronic device) that uses the electronic device.

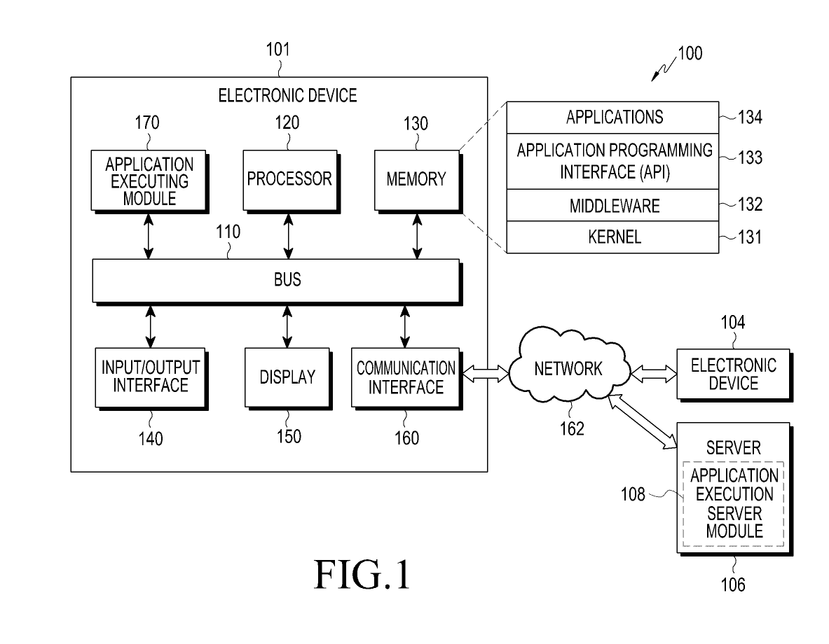

FIG. 1 is a block diagram illustrating a network environment including an electronic device according to various embodiments of the present disclosure.

Referring to a network environment 100 in FIG. 1, an electronic device 101 may include a bus 110, a processor 120, a memory 130, an input/output interface 140, a display 150, a communication interface 160, and an application executing module 170.

The bus 110 may be a circuit to connect the aforementioned components to each other and to allow communications (for example, transmission of control messages) between the aforementioned components.

The processor 120 may receive commands from the aforementioned components (for example, the memory 130, the input/output interface 140, the display 150, the communication interface 160, or the application executing module 170) through the bus 110, interpret the received commands, and perform operations or data processing according to the interpreted commands.

The memory 130 may store commands or data received from or created by the processor 120 or the components (for example, the input/output interface 140, the display 150, the communication interface 160, or the application executing module 170). The memory 130 may include programming modules, such as, for example, a kernel 131, middleware 132, an Application Programming Interface (API) 133, an application 134, and the like. Each of the programming modules may be software, firmware, hardware, or a combination of two or more of the aforementioned devices.

The kernel 131 may control or manage system resources (for example, the bus 110, the processor 120, or the memory 130) which the other programming modules (for example, the middleware 132, the API 133, or the application 134) use to execute their operations or functions. Also, the kernel 131 may provide an interface to enable the middleware 132, the API 133, or the application 134 to access and control (or manage) the components of the electronic device 101.

The middleware 132 may act as an intermediary layer so that the API 133 or the application 134 can communicate with the kernel 131 to receive/transmit data from/to the kernel 131. Also, the middleware 132 may perform, when operation requests are received from the application 134 (or a plurality of applications 134), controlling (for example, scheduling or load balancing) the operation requests, for example, by allocating priority for a system resource (for example, the bus 110, the processor 120, or the memory 130) to the application 134.

The API 133 may be an interface that enables the application 134 to control functions that are provided by the kernel 131 or the middleware 132. The API 133 may include at least one interface or function, for example, for file control, window control, image processing, character control, or the like.

According to various embodiments, the application 134 may be a Short Message Service (SMS)/Multimedia Messaging Service (MMS) application, an E-mail application, a calendar application, an alarm application, a health care application (for example, an application of measuring a workout or blood sugar), or an environmental information application (for example, an application of providing information about pressure, humidity, temperature, etc.). Additionally or alternatively, the application 134 may be an application related to data exchange between the electronic device 101 and an external electronic device (for example, an electronic device 104 or a server 106). The application related to data exchange may be, for example, a notification relay application to transfer specific information to the external electronic device or a device management application to manage the external electronic device.

For example, the notification relay application may relay notification information (for example, a SMS/MMS application, an E-mail application, a health care application, or an environmental information application) generated by another application of the electronic device 101 to the electronic device 104. Additionally or alternatively, the notification relay application may receive notification information from the electronic device 104 and provide the notification information to a user. The device management application may control a function of at least one component of the external electronic device that communicates with the electronic device 101, or manage (for example, install, delete, or update) an application or a service (for example, a call service or a message service) that is executed on or provided by the external electronic device. For example, the device management application may turn on/off a function of the electronic device 104, or adjust the brightness or the resolution of a display of the electronic device 104.

According to an embodiment, the application 134 may include an application designated according to an attribute (for example, the kind of device) of the external electronic device 104. For example, if the external electronic device is a digital audio player, the application 134 may include an application for playing music. Likewise, if the external electronic device is mobile medical equipment, the application 134 may include an application related to health-care. Thus, the application 134 may include at least one of an application designated by the electronic device 101 and an application received from an external electronic device such as, for example, the server 106 or the electronic device 104.

The input/output interface 140 may transfer a command or data received from a user through an input/output device (for example, a sensor, a keyboard, or a touch screen) to the processor 120, the memory 130, the communication interface 160, or the application executing module 170, for example, through the bus 110. For example, the input/output interface 140 may provide data related to a user's touch input received through a touch screen to the processor 120. Also, the input/output interface 140 may output a command or data received from the processor 120, the memory 130, the communication interface 160, or the application executing module 170, for example, via the bus 110, through an input/output device (for example, a speaker or a display). For example, the input/output interface 140 may output voice data processed by the processor 120 through a speaker.

The display 150 may display various information (for example, multimedia data or text data) for a user.

The communication interface 160 may enable the electronic device 101 to communicate with an external electronic device such as, for example, the electronic device 104 or the server 106. For example, the communication interface 160 may connect to a network 162 through wired or wireless communication to communicate with the external electronic device. The wireless communication may include at least one of Wireless Fidelity (WiFi), WiFi Direct, BlueTooth (BT), Near Field Communication (NFC), GPS, and cellular communication (for example, Long-Term Evolution (LTE), Long-Term Evolution Advanced (LTE-A), Code Division Multiple Access (CDMA), Wideband Code Division Multiple Access (WCDMA), Universal Mobile Telecommunications System (UMTS), Wireless Broadband (WiBro), Global System for Mobile Communications (GSM), and the like). The wired communication may include at least one of a Universal Serial Bus (USB), a High Definition Multimedia Interface (HDMI), Recommended Standard 232 (RS-232), and a Plain Old Telephone Service (POTS).

According to an embodiment, the network 162 may be a communication network. The communication network may include at least one of a computer network, the Internet, the Internet of Thing (IoT), and a telephone network. According to an embodiment, a protocol (for example, a transport layer protocol, a data link protocol, or a physical layer protocol) for communication between the electronic device 101 and an external electronic device may be supported by at least one of the application 134, the API 133, the middleware 132, the kernel 131, and the communication interface 160.

According to an embodiment, the application executing module 170 may perform operations (or, functions) that are implemented on the electronic device 101, thereby supporting driving of the electronic device 101. For example, the server 106 may include an application execution server module 108 that can support the application executing module 170 implemented on the electronic device 170. For example, the application execution server module 108 may include at least one component of the application executing module 170 to perform an operation that can be performed by the application executing module 170.

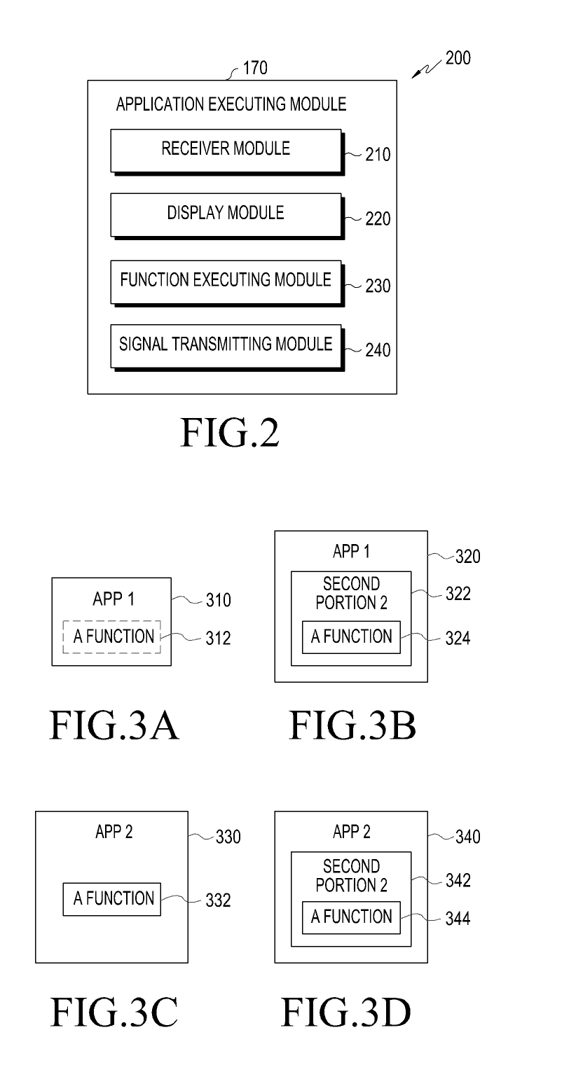

The application executing module 170 may process information acquired from the other components (for example, the processor 120, the memory 130, the input/output interface 140, or the communication interface 160) and use the processed information using various methods. For example, the application executing module 170 may control a function of the electronic device 101 using the processor 120 or independently from the processor 120 such that the electronic device 101 interworks with another electronic device (for example, the electronic device 104 or the server 106). The application executing module 170 may be integrated into the processor 120. According to an embodiment, at least one component of the application executing module 170 may be included in the server 106 (for example, the application execution server module 108) and the server 106 may support an operation that is implemented on the application executing module 170. The application executing module 170 will be described in more detail with reference to FIG. 2, below.

FIG. 2 is a block diagram illustrating the application executing module of an electronic device according to various embodiments of the present disclosure.

Referring to a block diagram 200 in FIG. 2, the application executing module 170 may include a receiver module 210, a display module 220, a function executing module 230, and a signal transmitting module 240.

The receiver module 210 may receive a user input that is applied on or near at least one area of a display (for example, the display 150) of the electronic device 101.

The display module 220 may display a screen of a first application, and display, in at least one area of the display, a first portion that is able to receive a user input and that is movable. The display module 220 may display a second portion that is larger than the first portion on the display in response to a user input received by the receiver module 210. The first portion may include at least one item such as text, a symbol, an image, or an icon. The first portion may be a selectable icon that does not include another item therein. The second portion may include at least one (that is, at least one item) of text, a symbol, and an icon that correspond to at least one of unique functions of the first application. As described herein, the term “application” may also be referred to as an “application program”.

According to various embodiments of the present disclosure, the function executing module 230 may execute at least one function of the first application in response to a user input that is applied on or near the second portion. The second portion may be a menu displayed in at least one area on a screen of the first application.

The screen of the first application may be configured to include a first item for enabling a user to select a function of the first application and the second portion may display a second item configured to enable a user to select the same function as that of the first item, wherein the second item may be larger than the first item. According to an embodiment, a size of the second item may be 1.2 to 2 times, 1.5 to 2 times, or 2 times larger than the size of the first item.

The first application may be an application including an input window and the second portion may include an item for enabling a user to select a mode allowing an input to the input window (for example, an address input window, a search keyword input window, or the like). The second portion may include an item (for example, a page movement/conversion button, a scroll button, or the like) for enabling a user to select displaying items that are different from currently displayed items. The second portion may be configured to display one of a plurality of pages each including at least one item. For example, the second portion may be configured to display one of the plurality of pages in response to a user input.

The first application may be executed by the electronic device or by an external device. At least one item for enabling a user to select at least one function of the first application may be linked with at least one function of a second application that is executed by an external device.

According to an embodiment, the display module 220 may display a screen of the second application on the display. While the screen of the second application is displayed, the display module 220 may display the first portion in at least one area of the display. The display module 220 may display a third portion on the display that is larger than the first portion in response to a user input applied on or near the first portion. The third portion may include at least one item for enabling a user to select at least one unique function of the second application. The third portion may include at least one of items included in the second portion. The third portion may have the same shape, color, and/or size as the second portion in at least one part.

According to an embodiment, the display module 220 may display a screen of the second application on the display while the second portion is displayed. The display module 220 may display at least one item for enabling a user to select at least one unique function of the second application in the second portion.

According to an embodiment, the display module 220 may display at least one part of the screen of the first application and at least one part of the screen of the second application at the same time on the display. In response to a user input applied on or near the second portion, the function executing module 230 may execute at least one function of the first application and at least one function of the second application, at least one function of the first application or the second application, or at least one function regardless of the first application and the second application.

According to an embodiment, the display module 220 may display a screen including at least one application icon on the display. While the screen is displayed, the display module 220 may display the first portion in at least one area of the display. In response to a user input applied on or near the first portion, the display module 220 may display a fourth portion that is larger than the first portion on the display. The fourth portion may include at least one item for enabling the user to select at least one function of the electronic device. According to an embodiment, the display module 220 may display at least one item for enabling the user to select at least one function of the application in the fourth portion.

According to an embodiment, while the second portion is displayed on the display, the display module 220 may display a screen of the second application. The display module 220 may display at least one item for enabling the user to select at least one function of the second application in the second portion.

According to an embodiment, the display module 220 may display a screen of the second application together with a screen of the first application on the display. The function executing module 230 may execute at least one function of the second application together with at least one function of the first application.

According to an embodiment, the display module 220 may display an item related to an external electronic device connected in a wired or wireless fashion to the electronic device in the second portion. In response to a user input applied on or near the item related to the external electronic device, the signal transmitting module 240 may transmit a signal to the external electronic device through a communication interface of the electronic device.

The signal transmitting module 240 according to various embodiments of the present disclosure may transmit a signal to the external device through a communication module of the electronic device. The signal may include information for causing the external electronic device to execute at least one function of the first application.

According to an embodiment, the display module 220 may display a first screen on the display. The display module 220 may search a memory of the electronic device for a database including information about at least one of unique functions of the first application. Based on at least one of the information, the display module 220 may display a portion in at least one area of the display, the portion including at least one item for enabling the user to select the at least one function. In response to a user input applied on or near to the portion, the function executing module 230 may execute at least one function of the first application. The information may include metadata related to at least one function of the unique functions of the first application, and the metadata may include at least one among a total number of the at least one function function, a number (or an identifier) of the function, a name of the function, an image representing the function, and a command or string allocated to the function. When the function executing module 230 executes the function of the first application, the function executing module 230 may search the database for a command stored to correspond to the function, the item or the user input applied on or near the portion and notify the found command to the first application. According to an embodiment, the function executing module 230 may receive a notification representing information about at least one function of the first application. The function executing module 230 may store the information in the database.

FIGS. 3A, 3B, 3C, and 3D are views for describing an application execution method according to various embodiments of the present disclosure.

Referring to FIG. 3A, a first application may display a screen 310 having an A function 312. The item may be text, a symbol, or an icon linked with the A function 312 of the first application. The A function 312 may be a function added when the first application is updated. If a user input applied on or near the item is received (or detected), the first application may execute the A function 312.

Referring to FIG. 3B, a screen 320 of a first application may be separated from a second portion 322. The second portion 322 may include an item 324 that is linked with the A function of the first application. If a user input is applied on or near the second portion 322 or the item 324, the first application may execute the A function.

Referring to FIG. 3C, a screen 330 of a second application may display an item 332 that is linked with an A function of a first application. The item 332 may correspond to the second portion. If a user input is applied on or near the second portion or the item 332, the first application may execute the A function.

Referring to FIG. 3D, a screen 340 of a second application may be separated from a second portion 342. The second portion 342 may include an item 344 that is linked with the A function of a first application. If a user input is applied on or near the second portion 342 or the item 344, the first application may execute the A function.

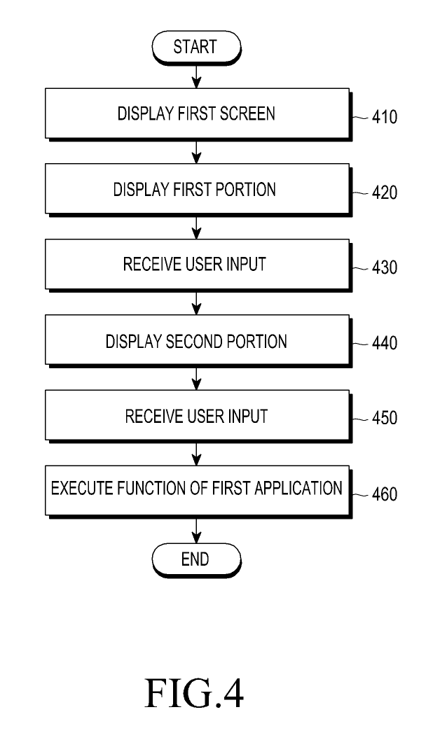

FIG. 4 is a flowchart illustrating an application execution method according to various embodiments of the present disclosure.

Referring to FIG. 4, the execution method may include operations 410 to 460. At operation 410, a first screen may be displayed on a display of the electronic device. The first screen may be a screen of a first application, a screen of a second application, or a home screen.

The first application may be executed by a user's hovering gesture, a user's touch gesture, a user's line of sight, a user's motion gesture, a user's voice command, or an automatic execution setting.

For example, the first application may be executed according to a user's selection or an automatic setting, and a screen of the first application may be displayed on a display of the electronic device. A screen of the application may also be referred to as a Graphical User Interface (GUI), an application screen, or an application window. The first application may be an application provided by a manufacturer of the electronic device or may be an application installed by a user. Also, the first application may be an application set to automatic execution by a first configuration setting or an application that is automatically executed according to occurrence of an event (e.g., reception of a message, reception of a call, occurrence of an alarm event, or the like).

When an application is executed by a user input, the user input may be received through an input/output interface (for example, the input/output interface 140), a sensor module, a communication interface (for example, the communication interface 160), or a display (for example, the display 150). The user may select a button, an icon, or a menu (or, a menu item) through the input/output interface or the display, input a voice command through a microphone of the input/output interface, input a gesture or a motion through a camera of the sensor module, or input an execution command of a specific application wirelessly through the communication interface.

A screen may correspond to an image that is displayed on the display when an application is executed.

A gesture input or a motion input may be for a user to draw a trajectory of a predetermine pattern, such as a line, a circle, a polygon (triangle or rectangle), a zigzag, or the like, in the air within an angle of view of a camera module or within a sensing range of a sensing module, with the user's hand or finger. Herein, the gesture may also be referred to as a spatial gesture in order to distinguish it from a touch gesture. The touch gesture may be provided when a user's finger or hand directly touches the display or hovers over the display.

A touch gesture using a user input unit (for example, a user's finger or pen) may include at least one among a touch, a long touch, a tap, a double tap, a flick, a drag (or a touch-and-move), a drag-and-drop, a swipe, multi-swipes, pinches, shaking, and a rotation, according to an input method. The touch may be a gesture of putting the user input unit on the display 150, the long touch (or a touch-and-hold) may be a gesture of touching and holding the display, the tap may be a gesture of tapping the display one time, the double tap may be a gesture of tapping the display two times, the flick may be a gesture (for example, scrolling) of putting the user input unit on the display and moving the user input unit on the display, the drag may be a gesture of moving or scrolling an item displayed on the display, the drag-and-drop may be touching and dragging an item on the display and then removing the item off the display, the swipe may be touching the display with the user input unit and dragging the user input unit by a predetermined distance, the multi-swipes may be touching the display with two user input units and then dragging the user input units, and the pinch may be touching the display with two user input units and then dragging the user input units in different directions.

At operation 420, a first portion for receiving a user input may be displayed in at least one area of the display. The first portion may be displayed as a movable icon.

At operation 430, a user input may be applied on or near the first portion to select the first portion.

At operation 440, in response to selecting the first portion, a second portion that is larger than the first portion may be displayed in at least one area of the display that is functionally connected to the electronic device. The second portion may include at least one item for enabling the user to select at least one function of the first application. The at least one item may include at least one of text, at least one symbol, and at least one icon, which are linked with the function of the first application. The second portion may be displayed as a movable window.

At operation 450, a user input is applied on or near the second portion to select the item of the second portion.

At operation 460, in response to selecting the item of the second portion, the function of the first application may be executed. The first application may display the results of the function execution. The function execution by the first application include displaying a second screen of the first application according to execution of the at least one function, changing settings of the first application, changing system settings (changing a lock screen, an idle screen, or a home screen), or changing device settings (adjusting the volume or the screen brightness).

The first application may be executed by the electronic device or by an external device. The at least one item for enabling the user to select at least one function of the first application may be linked with at least one function of the second application that is executed by an external device.

The function execution by the first application may include transmitting a signal to the external device through a communication interface of the electronic device, and the signal may include information for enabling the external device to execute the at least one function of the first application or the second application.

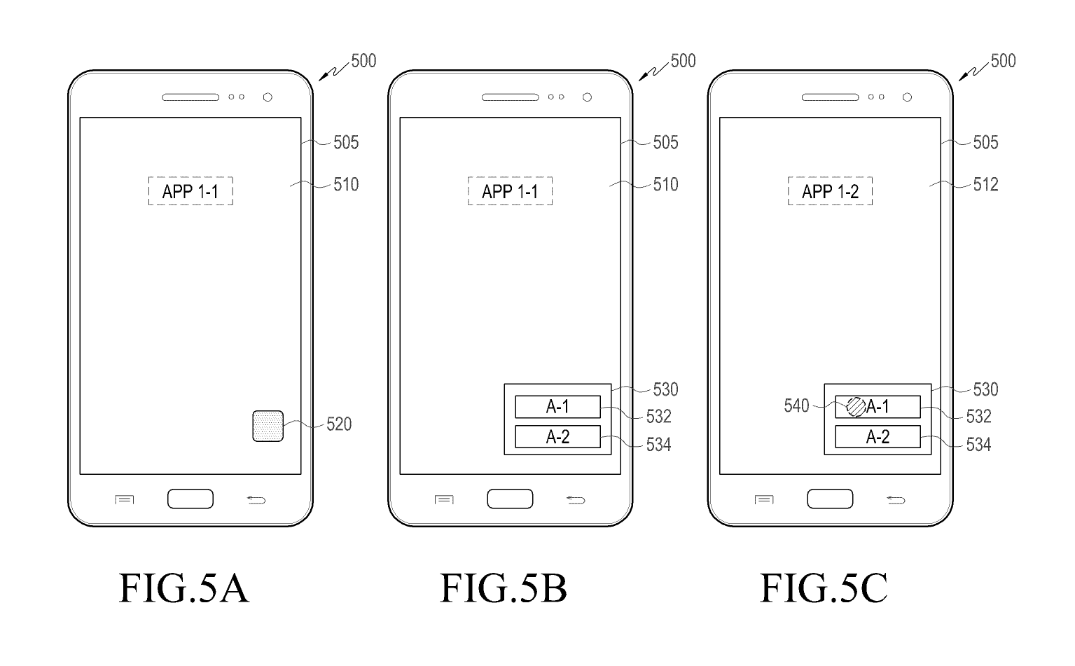

FIGS. 5A, 5B, 5C, 6A, 6B, 6C, 7A, 7B, 7C, 8A, 8B, 8C, 9A, and 9B are views for describing application execution methods of an electronic device, according to various embodiments of the present disclosure.

Referring to FIG. 5A, a first screen 510 of a first application may be displayed in at least one area of a display 505 of an electronic device 500. A first portion 520 may be displayed in the at least one area or another area of the display 505.

If a user input for selecting the first portion 520 is received (or detected), as shown in FIG. 5B, a second portion 530 that is larger than the first portion 520 may be displayed in at least one area of the display 505. The second portion 530 may include at least one of an A-1 item 532 and an A-2 item 534 for enabling a user to select at least one of unique functions of the first application. Each of the A-1 item 532 and the A-2 item 534 may be text, a symbol, or an icon linked with a function of the first application.

If a user input (540) for selecting the A-1 item 532 is received, as shown in FIG. 5C, a second screen 512 of the first application, which represents execution results of the A-1 item 532, may be displayed on the display 505.

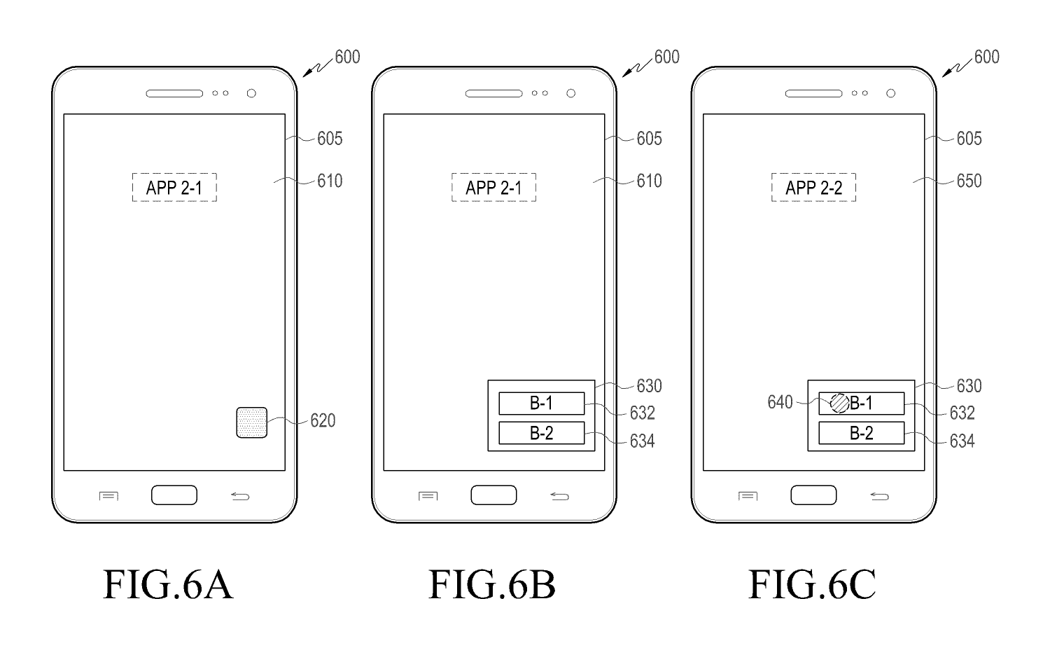

Referring to FIG. 6A, a first screen 610 may be displayed in at least one area of a display 605 of an electronic device 600. A first portion 620 may be displayed in the at least one area or another area of the display 605.

If a user input for selecting the first portion 620 is received, as shown in FIG. 6B, a third portion 630 may be displayed in at least one area of the display 605. The third portion 630 may include at least one of a B-1 item 632 and a B-2 item 634 for enabling a user to select at least one of unique functions of a second application.

If a user input (640) for selecting the B-1 item 632 is received, as shown in FIG. 6C, a second screen 650 of the second application, which represents execution results of the B-1 item 632 may be displayed on the display 605.

At least one of the shape, color, or size of the third portion 630 may be at least partially identical to, similar to, or different from that of the second portion 530.

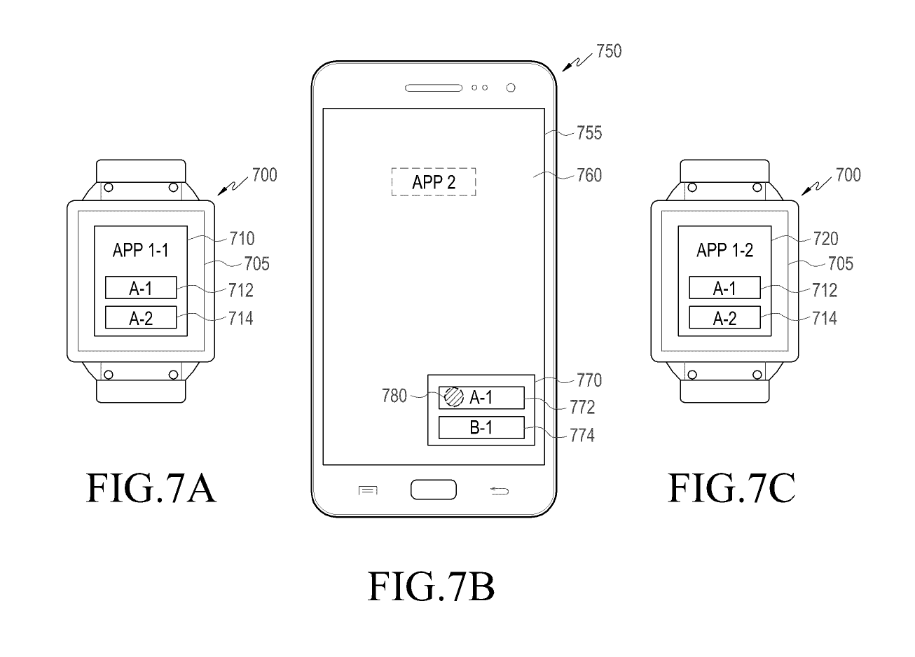

Referring to FIG. 7A, a first screen 710 of a first application may be displayed in at least one area of a display 705 of an external device 700. The first screen 710 may include at least one of an A-1 item 712 and an A-2 item 714 for enabling a user to select at least one of unique functions of the first application. Each of the A-1 item 712 and the A-2 item 714 may be text, a symbol, or an icon linked with a function of the first application.

Referring to FIG. 7B, a first screen 760 of a second application may be displayed in at least one area of a display 755 of an electronic device 750. A second portion 770 may be displayed in the at least one area or another area of the display 755. The second portion 770 may include at least one of an A-1 item 772 for enabling a user to select at least one of unique functions of the first application and a B-1 item 774 for enabling a user to select at least one of unique functions of the second application. Each of the A-1 item 772 and the B-1 item 774 may be text, a symbol, or an icon linked with the corresponding application.

If a user input (780) for selecting the A-1 item 772 displayed on the display 755 of the electronic device 750 is received, as shown in FIG. 7C, a second screen 720 of the first application, which represents execution results of the A-1 item 772 may be displayed on the display 705 of the external device 700.

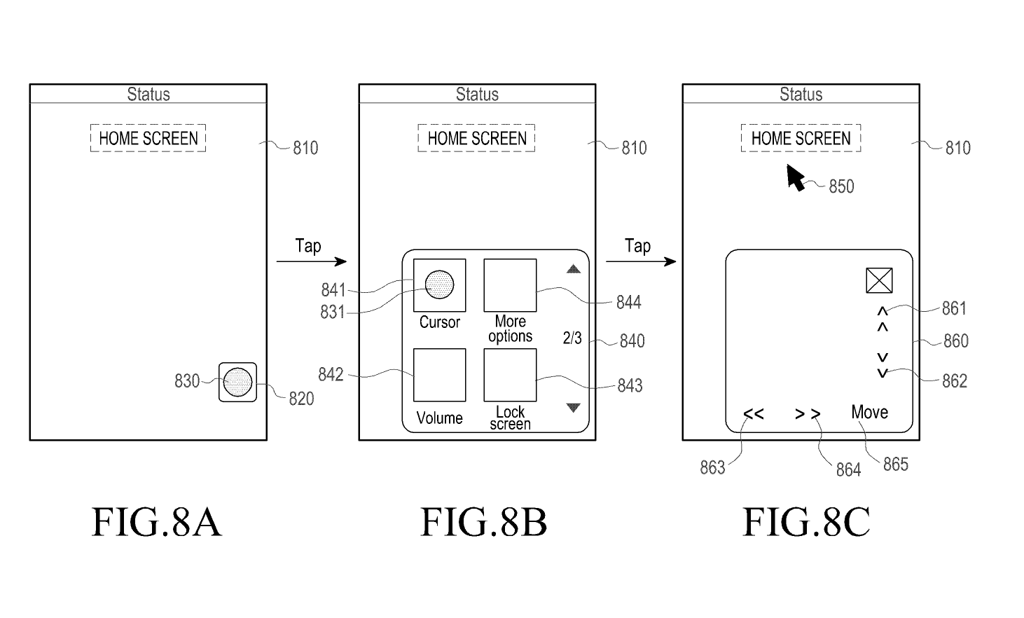

Referring to FIG. 8A, a home screen 810 including at least one application icon may be displayed in at least one area of a display of an electronic device. While the home screen 810 is displayed, a first portion 820 may be displayed in the at least one area or another area of the display.

If a user input (830) for selecting the first portion 820 is received, as shown in FIG. 8B, a fourth portion 840 that is larger than the first portion 820 may be displayed in at least one area of the display. The fourth portion 840 may include items for enabling a user to select functions (for example, a system menu or a device menu) of the electronic device. Each item may be text, a symbol, or an icon linked with a function of the electronic device. The fourth portion 840 may include at least one of a first item 841 for displaying/moving/controlling a cursor on a screen, a second item 842 for adjusting/controlling the volume, a third item 843 for displaying/controlling a lock screen, and a fourth item 844 for displaying other items. According to an embodiment of the present disclosure, the fourth portion 840 may include at least one item for enabling a user to select at least one function of the corresponding application.

If a user input (831) (for example, a tap gesture) for selecting the first item 841 is received, as shown in FIG. 8C, a cursor 850 and a fifth portion 860 may be displayed in at least one area of the display. The fifth portion 860 may include items for moving/controlling the cursor 850 and items for moving/controlling the fifth portion 860. For example, the fifth portion 860 may include at least one among an upward movement item 861, a downward movement item 862, a leftward movement item 863, and a rightward movement item 864 for moving the cursor 850, and a window movement item 865 for moving the fifth portion 860.

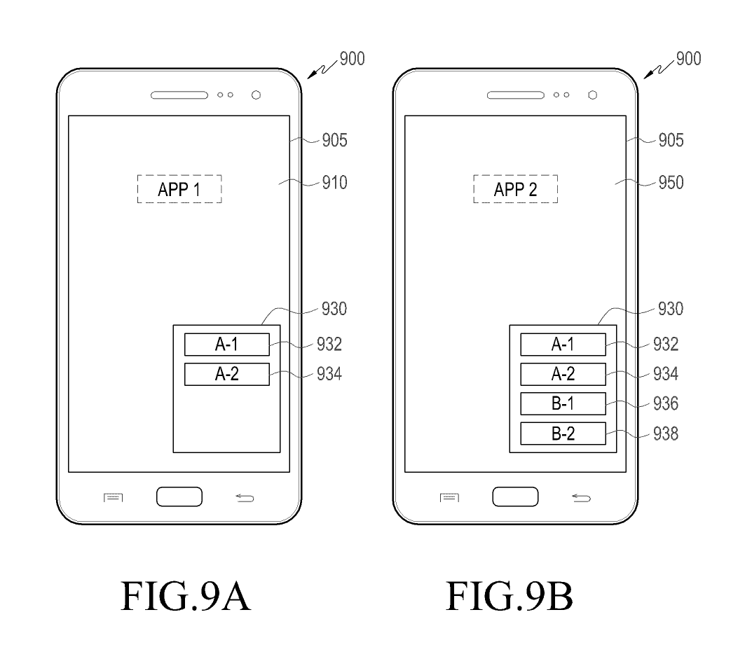

Referring to FIG. 9A, a first screen 910 of a first application may be displayed in at least one area of a display 905 of an electronic device 900. A second portion 930 may be displayed in the at least one area or another portion of the display 905. The second portion 930 may include at least one of an A-1 item 932 and an A-2 item 934 for enabling a user to select at least one of unique functions of the first application. Each of the A-1 item 932 and the A-2 item 934 may be text, a symbol, or an icon.

Referring to FIG. 9B, while the second portion 930 is displayed, a screen 950 of a second application may be displayed on the display 905. When the screen 950 of the second application is displayed, at least one of a B-1 item 936 and a B-2 item 938 for enabling a user to select at least one of unique functions of the second applications may be displayed in the second portion 930. According to an embodiment of the present disclosure, the second portion 930 may be at least one item for enabling a user to select at least one of functions (for example, a system menu or a device menu) of the electronic device 900.

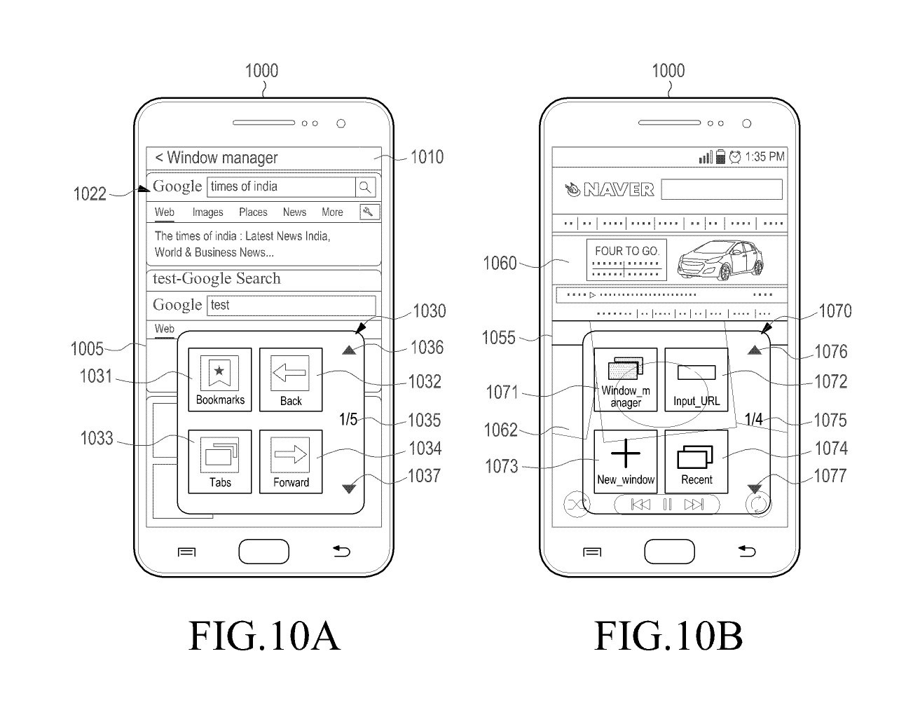

FIGS. 10A, 10B, 11A, 11B, 12A, 12B, 13A, and 13B are views for describing application execution methods in a multi-window environment, according to various embodiments of the present disclosure.

Referring to FIG. 10A, applications being currently executed may be displayed in at least one area of a display 1005 of an electronic device 1000. A second portion 1030 may be displayed in the at least one area or another area of the display 1005. The second portion 1030 may include a plurality of items, and each item may be text, a symbol, or an icon linked with a function of the corresponding application. If a user input is received through one of the items included in the second portion 1030, in response to the user input, a function linked with the item may be executed on at least one of the first application or the second application. According to an embodiment of the present disclosure, the first and second applications may be browser applications. The second portion 1030 may selectively display one of a plurality of pages and each page may display items linked with functions of the corresponding application. The second portion 1030 may include information 1035 about a total number of pages and a number of a currently displayed page and items 1036 and 1037 for page up/down. According to an embodiment of the present disclosure, the second portion 1030 may display at least one of a bookmarks item 1031, a tabs item 1033, a back item 1032, or a forward item 1034. According to an embodiment of the present disclosure, if a user input for selecting the back item 1032 is received, a function (for example, moving backward) linked with the back item 1032 may be executed on at least one of the first application or the second application.

Referring to FIG. 10B, an entire screen of a display 1055 of an electronic device 1050 may be divided into a upper area and a lower area, the upper area may display a first screen 1060 of a first application (for example, a browser application) and the lower area may display a second screen 1062 of a second application (for example, a music application). A second portion 1070 may be displayed in the at least one area of the display 1055. A second portion 1070 may include a plurality of items and each item may be text, a symbol, or an icon linked with a function of the electronic device 1050. If a user input is received through an item in the second portion 1070, a function linked with the selected item may be executed on at least one of the first application and the second application in response to the user input. According to an embodiment of the present disclosure, the second portion 1070 may include at least one of a first item 1071 for executing a window manager, a second item 1072 for enabling a user to input a Uniform Resource Locator (URL), a third item 1073 for displaying a new window, and fourth item 1074 for displaying a list of websites a user visited recently. Also, the second portion 1070 may include at least one of information 1075 about a total number of pages and a number of a currently displayed page, a page up item 1076 for page up, and a page down item 1077 for page down. If the second item 1072 for enabling a user to input a URL is selected, the first screen 1060 of the first application (for example, a browser application) may enter a state or a mode allowing a user to input a URL to an address input window.

In a multi-window environment, if an item of a second portion is selected, the first application and the second application may be executed at the same time, or an application currently focused (or activated) may be executed. The second portion may display functions of all applications of the multi-window, functions of a focused application, or functions of applications not having the focus. Also, in the multi-window environment, 2 to n applications may be executed and the second portion may display functions of the 2 to n applications, functions of a focused application, or functions of applications not focused.

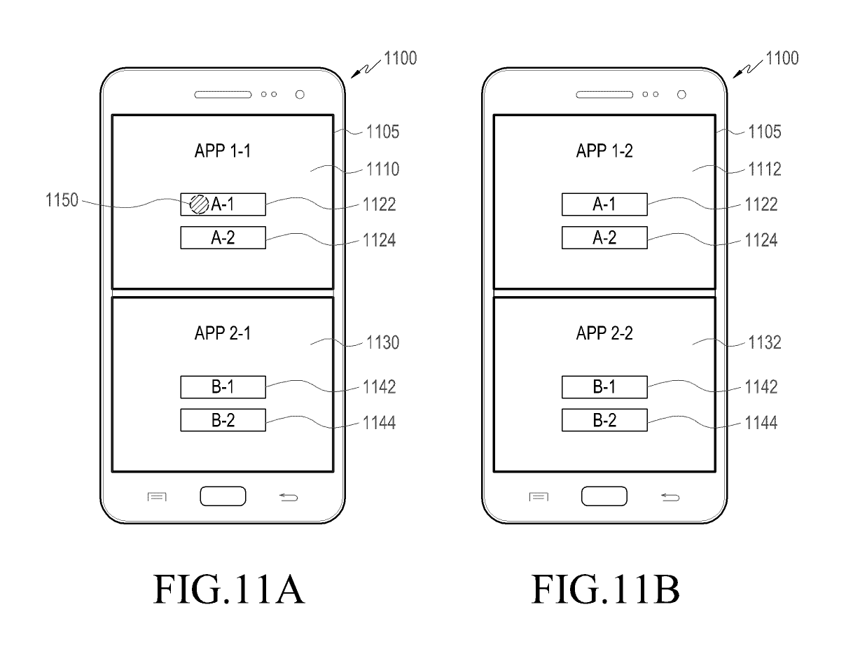

Referring to FIG. 11A, a first screen 1110 of a first application may be displayed in at least one area of a display 1105 of an electronic device 1100. The first screen 1110 of the first application may include at least one of an A-1 item 1122 and an A-2 item 1124 for enabling a user to select at least one of unique functions of the first application. Each of the A-1 item 1122 and the A-2 item may be text, a symbol, or an icon linked with a function of the first application. Together with the first screen 1110 of the first application, a first screen 1130 of a second application may be displayed in at least one area of the display 1105 of the electronic device 1100. The first screen 1130 of the second application may include at least one of a B-1 item 1142 and a B-2 item 1144 for enabling a user to select at least one of unique functions of the second application. Each of the B-1 item 1142 and the B-2 item 1144 may be text, a symbol, or an icon linked with a function of the second application.

At least one item for enabling a user to select at least one function of the first application may be linked with at least one function of the second application. At least one item for enabling a user to select at least one function of the second application may be linked with at least one function of the first application.

For example, the A-1 item 1122 and the B-1 item 1142 may be linked with each other.

If a user input for selecting the A-1 item 1122 is received at reference numeral 1150, as shown in FIG. 11B, a second screen 1112 of the first application, which represents execution results of the A-1 item 1122, may be displayed on the display 1105, and a second screen 1132 of the second application, which represents execution results of the B-1 item 1142, may be displayed on the display 1105.

The first and second applications may be the same kind of applications or may be different kinds of applications.

For example, in a multi window environment, when a first web browser application and a second web browser application are executed, if a user input for selecting a back button is received through any one of the first and second web browser applications, a back function may be executed on both the first and second web browser applications.

In another example of a multi-window environment, when a web browser application and a phone book application are executed, if a user input for selecting a bookmark button is received through any one of the first and second web browser applications, a bookmark function may be executed on both the first and second web browser applications.

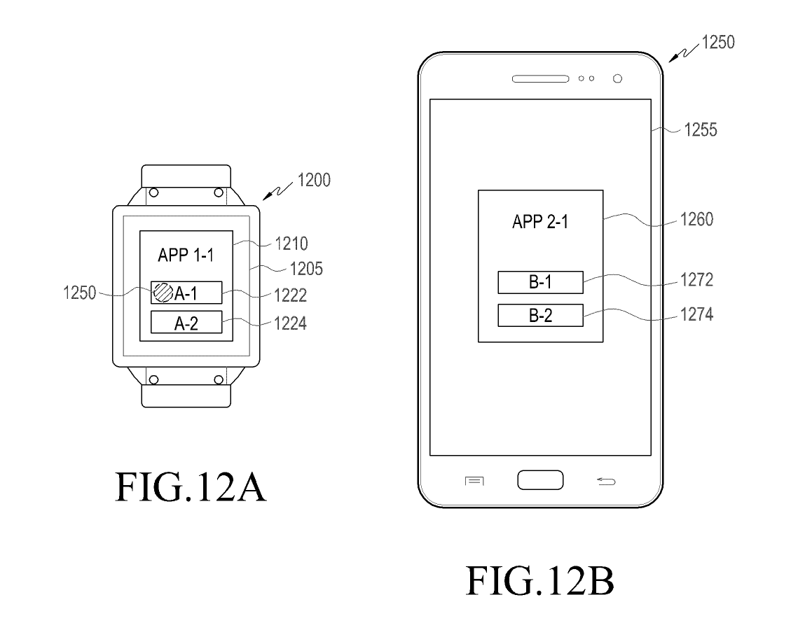

Referring to FIG. 12A, a first screen 1210 of a first application may be displayed in at least one area of a display 1205 of an external device 1200. The first screen 1210 of the first application may include at least one of an A-1 item 1222 and an A-2 item 1224 for enabling a user to select at least one of unique functions of the first application. Each of the A-1 item 1222 and the A-2 item 1224 may be text, a symbol, or an icon linked with a function of the first application.

Referring to FIG. 12B, a first screen 1260 of a second application may be displayed in at least one area of a display 1255 of an electronic device 1250. The first screen 1260 of the second application may include at least one of a B-1 item 1272 and a B-2 item 1274 for enabling a user to select at least one of unique functions of the second application. Each of the B-1 item 1272 and the B-2 item 1274 may be text, a symbol, or an icon linked with a function of the second application.

For example, at least one item for enabling a user to select at least one function of the first application may be linked with at least one function of the second application. According to another example, at least one item for enabling a user to select at least one function of the second application may be linked with at least one function of the first application.

In this example, the A-1 item 1222 and the B-1 item 1272 may be linked with each other.

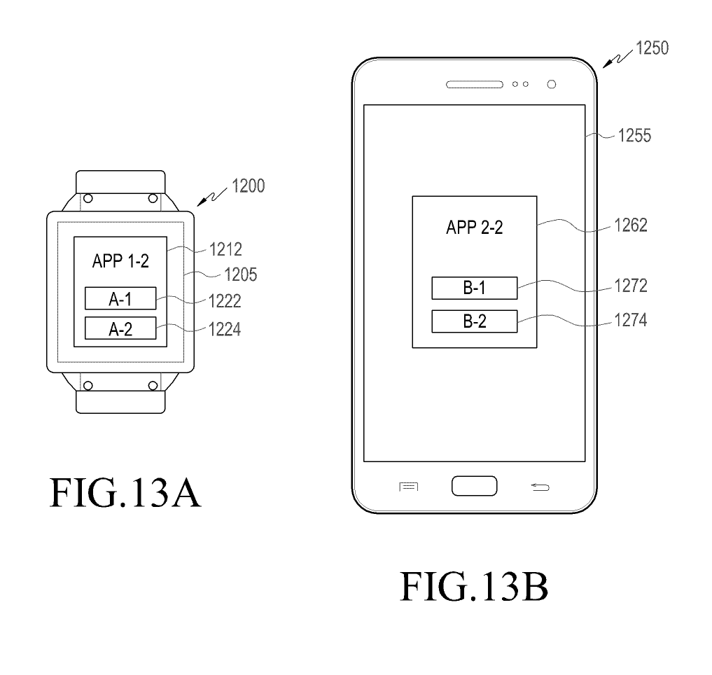

If a user input for selecting the A-1 item 1222 is received at reference numeral 1250 as shown in FIG. 13A, a second screen 1212 of the first application, which represents execution results of the A-1 item 1222, may be displayed on the display 1205 and, as shown in FIG. 13B, a second screen 1262 of the second application, which represents execution results of the B-1 item 1272, may be displayed on the display 1255.

The first and second applications may be the same kind of applications or may be different kinds of applications.

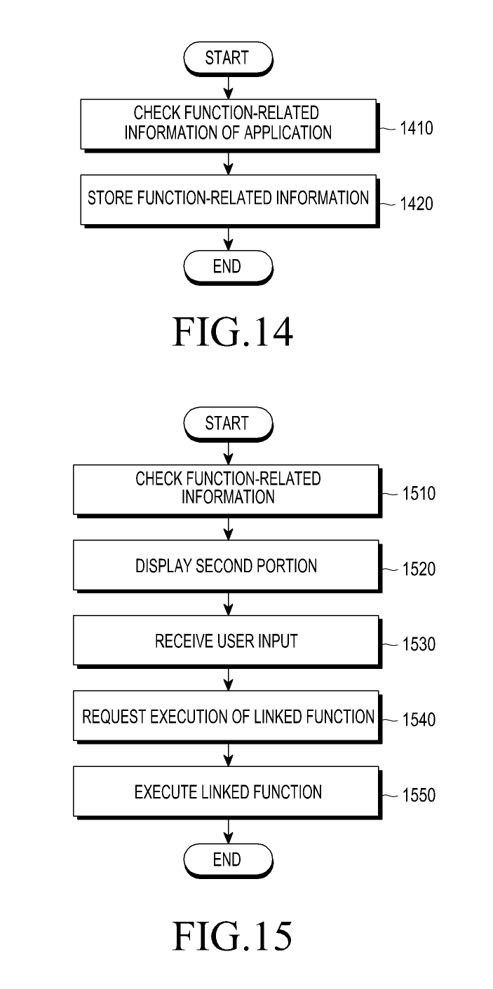

FIGS. 14 and 15 are flowcharts illustrating an application execution method according to various embodiments of the present disclosure.

Referring to FIG. 14, the application execution method may include operations 1410 and 1420. At operation 1410, function-related information of an application may be checked by receiving a notification informing of function-related information of the application. However, the function-related information of an application may be checked during a booting process of an electronic device (for example, the electronic device 101 of FIG. 1).

The notification may include a direct notification by the application and an indirect notification using a memory (for example, the memory 130 of FIG. 1).

The application may receive a check request and may notify function-related information in response to the check request.

The function-related information may include information about modification (for example, addition, deletion, or correction) of at least one function, modification (for example, addition, deletion, correction, name modification) of an API, and modification of at least one resource (for example, an image or a string).

The function-related information may include metadata about functions of the application, and the metadata may include a total number of the functions, a number (or an identifier) of the function, at least one image (for example, an icon) representing the function, and at least one command (or at least one string) allocated to the function.

At operation 1420, the function-related information of the application may be stored or updated in a database. The memory of the electronic device may store function-related information of at least one application in at least one database. By storing the metadata, the functions of the application may be registered in the database. The metadata may be classified according to applications, according to functions, or according to categories (for example, activities), and stored.

The received metadata or metadata-related information may be compared to metadata or metadata-related information stored in advance in the database and a part of the received metadata that is different from the stored metadata may be stored (or updated) in the database.

Referring to FIG. 15, the application execution method may include operation 1510 to operation 1550.

At operation 1510, function-related information of an application may be checked based on information stored in a memory (for example, the memory 130 of FIG. 1).

At operation 1520, a second portion may be created based on the stored information and the second portion may be displayed in at least one area of a display (for example, the display 150 of FIG. 1) of an electronic device (for example, the electronic device 101 of FIG. 1). The second portion may include a plurality of items and each item may be text, a symbol, or an icon linked with a function of the electronic device and/or with a function of an application. The second portion may include a resource (for example, a button image) based on a resource name (or a storage location or an address in a memory) included in metadata.

At operation 1530, a user input or a user selection applied on the item of the second portion may be received.

At operation 1540, a request or a command for executing a function linked with the item selected by the user may be provided to the application. A command or a string stored to correspond to the selected item may be searched from information stored in the memory and the found command may be notified to the application.

At operation 1550, the application may execute the function linked with the item and provide the results of the function execution to the user. The function execution may be executing a function (for example, displaying/changing a screen, information displaying/browsing, screen activation/deactivation, or multimedia control) of the application, changing settings of the application, changing an operation mode of the application, or executing a function of the electronic device. The application that receives the request for executing the function may display a screen showing the results of the function execution.

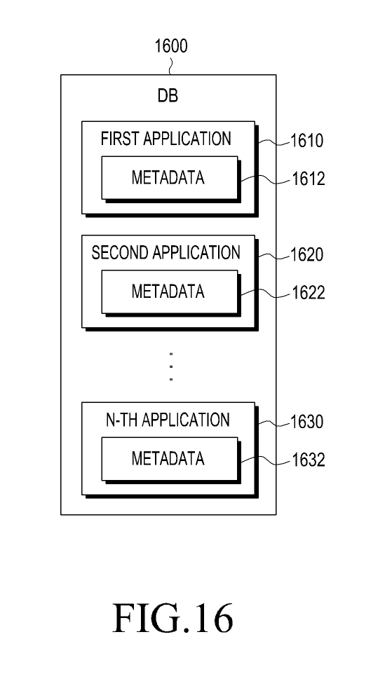

FIG. 16 illustrates a configuration of database according to various embodiments of the present disclosure.

Referring to FIG. 16, database 1600 may store metadata for N applications and/or information extracted from the metadata of each of the N applications. The database 1600 may include metadata 1612 for function-related information of a first application 1610, metadata 1622 for function-related information for a second application 1620, and metadata 1632 for function-related information for an N-th application 1630. The metadata for the applications may be classified according to functions of the applications or according to categories (for example, activities) of the applications.

The term “activity” means a screen (that is, an application screen that is shown on a display when the application is executed). An activity may represent a screen and an application that is displayed with a plurality of screens may include a plurality of activities. A message application may include a first activity displaying a list of reception or transmission messages and a second activity displaying details of the messages. A browser application may include a bookmark activity, a tab activity, and a web main activity. The database may include metadata related to a bookmark activity, metadata related to a tab activity, and metadata related to a web main activity.

The term “bookmark” means a function of a user registering a URL of a web site in a browser application or a list of registered URLs. The bookmark activity may represent a screen related to bookmark. The term “tab” or “tab browsing” means a function of creating several tabs in a window to perform browsing through each tab. The tab activity may represent a screen related to tab or tab browsing. The term “web main” means a screen of a web site. The web main activity may represent a screen related to a web main.

A format of metadata stored in the database 1600 according to various embodiments of the present disclosure is shown in Table 1, below.

TABLE 1

<metadata>
<number of buttons>
<name>
<drawable>
<intent action string>
<buttons>
</metadata>

The <metadata> element (or tag) may represent a start of the metadata, the <number of buttons> element may represent the total number of buttons, the <name> element may represent names of the buttons (or functions), the <drawable> element may represent a resource name (or a storage location or address in a memory), the <intent action string> element may represent commands allocated to the buttons, the </buttons> element may represent an end of a list of the buttons, and the <metadata> element (or tag) may be an end of the metadata.

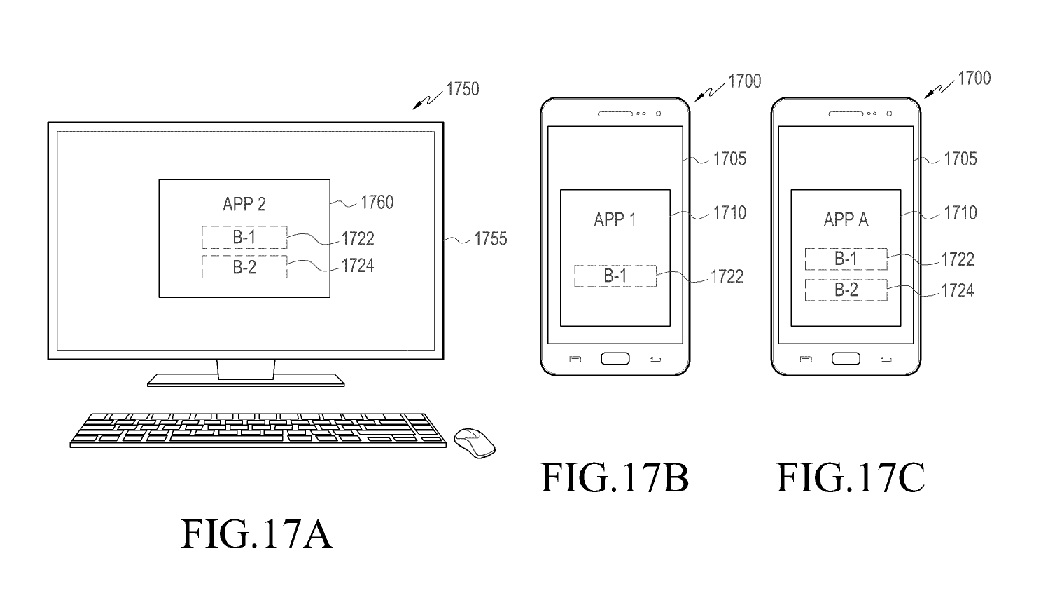

FIGS. 17A, 17B, and 17C are views for describing operations of a server and electronic devices according to various embodiments of the present disclosure.

Referring to FIG. 17A, a second application may be installed in a server 1750 and the server 1750 may display a second screen 1760 on a display 1755. The second screen 1760 may include at least one of a B-1 item 1722 and a B-2 item 1724 for enabling a user to select at least one of unique functions of the second application. The server 1750 may have a function linked with at least one of the B-1 item 1722 and the B-2 item 1724 without installing the second application.

Referring to FIG. 17B, a first application may be installed in an electronic device 1700 that can communicate with the server 1750 and a display 1705 of the electronic device 1700 may display a second portion 1710 linked with a function of the first application. The second portion 1710 may include a B-1 item 1722 for enabling a user to select at least one of unique functions of the second application.

According to an embodiment, if the second application includes a B-2 item 1724 in addition to the B-1 item 1722 through updating (or although updating is not performed, applications having the same function, the same name, or the same shape can be linked and executed), the second application (or the server 1750) may transmit a notification (for example, signal transmission through a communication module) including information about the B-2 item 1724 to the first application (or the electronic device 1700).

Referring to FIG. 17C, the first application (or the electronic device 1700) may store function-related information of the second application in database. The first application may display an updated second portion 1710 based on the database. The updated second portion 1710 may include at least one of the B-1 item 1722 and the B-2 item 1724.

According to various embodiments of the present disclosure, an electronic device may include a touch-sensitive display and a processor configured to display a screen of a first application program on the display, wherein the processor may be configured to display a first portion on the display that is able to receive a user input and that is movable to receive a user input applied on or near the first portion displayed on the display, and to display a second portion that is larger than the first portion, in response to the user input, on the display, the second portion including at least one item for enabling a user to select at least one of unique functions of the first application program.

According to various embodiments of the present disclosure, the first portion may include one or more of text, a symbol, an image, or an icon.

According to various embodiments of the present disclosure, the processor may be configured to receive a user input applied on or near the second portion and to execute at least one function of the first application program in response to the user input.

According to various embodiments of the present disclosure, the second portion may include a menu displayed in at least one area of the screen of the first application program, and the at least one item may include at least one of text, a symbol, an image, a moving image, or an icon.

According to various embodiments of the present disclosure, the screen of the first application program may be configured to include a first item for enabling a user to select one of unique functions of the first application program, the second portion may display a second item for enabling a user to select the same function of the first item, and the second item may be larger than the first item.

According to various embodiments of the present disclosure, the first application program may include an application program including an input window, and the second portion may include an item for enabling a user to select a mode allowing an input to the input window.

According to various embodiments of the present disclosure, the second portion may further include an item for enabling a user to select displaying items that are different from currently displayed items.

According to various embodiments of the present disclosure, the second portion may be configured to display one of a plurality of pages each including at least one item, and the processor may be configured to display one of the plurality of pages in response to a user input.

According to various embodiments of the present disclosure, the second portion may further include at least one item for enabling a user to select a function related to a system or component of the electronic device.

According to various embodiments of the present disclosure, the processor may be configured to display a screen of a second application program through the display, to display the first portion in at least one area of the display while the screen of the second application program is displayed, to receive a user input applied on or near the first portion, and to display a third portion that is larger than the first portion, on the display, in response to the user input, wherein the third portion may include at least one item for enabling a user to select at least one of unique functions of the second application program.

According to various embodiments of the present disclosure, the third portion may further include at least one item of items included in the second portion.

According to various embodiments of the present disclosure, at least one of the shape, color, and size of the third portion may be at least partially identical to or similar to that of the second portion.

According to various embodiments of the present disclosure, the processor may be configured to display a screen of a second application program through a display of the electronic device while the second portion is displayed, and to display at least one item for enabling a user to select at least one of unique functions of the second application program, on the second portion.

According to various embodiments of the present disclosure, the processor may be configured to display at least one part of a screen of the first application program and at least one part of a screen of the second application program, at the same time, on the display, to receive a user input applied on or near the second portion, and to execute at least one function of the first application program and at least one function of the second application program, in response to the user input, to execute at least one function of the first application program or the second application program, in response to the user input, or to execute at least one function regardless of the first and second application programs, in response to the user input.

According to various embodiments of the present disclosure, the processor may be configured to further display an item related to an external electronic device connected in a wired or wireless fashion to the electronic device, in the second portion, to receive a user input applied on or near the item related to the external electronic device, and to transmit a signal to the external electronic device through a communication module of the electronic device, in response to the user input.

According to various embodiments of the present disclosure, the processor may be configured to display a screen including at least one application program icon on a display of the electronic device, to display the first portion in at least one area of the display while the screen is displayed, to receive a user input applied on or near the first portion, and to display a fourth portion that is larger than the first portion, on the display, in response to the user input, wherein the fourth portion may include at least one item for enabling a user to select at least one of functions of the electronic device.

According to various embodiments of the present disclosure, an application execution method of an electronic device may include operations of: displaying a screen of a first application program on a touch-sensitive display of the electronic device; displaying a first portion that is able to receive a user input and that is movable, on the display; receiving a user input applied on or near the first portion displayed on the display; and displaying a second portion that is larger than the first portion, on the display, wherein the second portion may include at least one item for enabling a user to select at least one of unique functions of the first application program.

According to various embodiments of the present disclosure, the application execution method may further include operations of receiving a user input applied on or near the second portion, and executing at least one function of the first application program in response to the user input.

According to various embodiments of the present disclosure, the second portion may include a menu displayed in at least one area of a screen of the first application program, and the at least one item may include at least one of text, a symbol, an image, a moving image, or an icon.

According to various embodiments of the present disclosure, the screen of the first application program may be configured to include at least one item for enabling a user to select one of unique functions of the first application program, wherein the second portion may display a second item for enabling a user to select the same function of that of the first item, and the second item may be larger than the first item.

According to various embodiments of the present disclosure, the application execution method may further include operations of displaying a screen of a second application through the display, displaying the first portion in at least one area of the display while the screen of the second application program is displayed, receiving a user input applied on and near the first portion, displaying a third portion that is larger than the first portion, on the display, in response to the user input, wherein the third portion may include at least one item for enabling a user to select at least one of unique functions of the second application program.

According to various embodiments of the present disclosure, the third portion may further include at least one item among items included in the second portion.

According to various embodiments of the present disclosure, the application execution method may further include operations of displaying a screen of a second application program through the display of the electronic device while the second portion is displayed, and displaying at least one item for enabling a user to select at least one of unique functions of the second application program, in the second portion.

According to various embodiments of the present disclosure, the application execution method may further include operations of displaying at least one area of a screen of the first application program and at least one area of a screen of a second application program, at the same time, on the display; receiving a user input applied on or near the second portion, and executing at least one function of the first application program and at least one function of the second application program, in response to the user input, executing at least one function of the first application program or the second application program, in response to the user input, or executing at least one function regardless of the first and second application programs, in response to the user input.

According to various embodiments of the present disclosure, the application execution method may further include operations of further displaying an item related to an external electronic device connected in a wired or wireless fashion to the electronic device, in the second portion, receiving a user input applied on or near the item related to the external electronic device, and transmitting a signal to the external electronic device through a communication module of the electronic device, in response to the user input.

According to various embodiments of the present disclosure, the application execution method may further include operations of: displaying a screen including at least one application program icon on a display of the electronic device; displaying the first portion in at least one area of the display while the screen is displayed; receiving a user input that is applied on or near the first portion; and displaying a fourth portion that is larger than the first portion, on the display, in response to the user input, wherein the fourth portion may include at least one item for enabling a user to select at least one of functions of the electronic device.

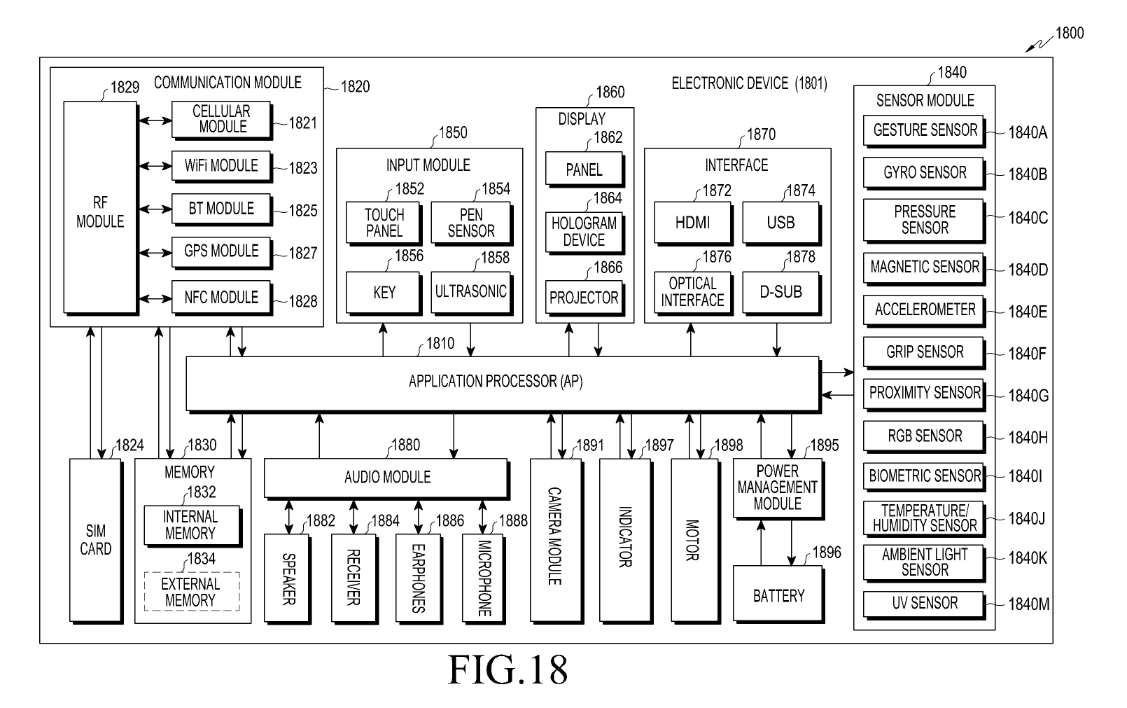

FIG. 18 is a block diagram of an electronic device according to various embodiments of the present disclosure.

Referring to the block diagram 1800 in FIG. 18, the electronic device 1801 may configure the entire or a part of the electronic device 101 shown in FIG. 1. Referring to FIG. 18, the electronic device 1801 may include at least one of at least one Application Processor (AP) 1810, a communication module 1820, a Subscriber Identification Module (SIM) card 1824, a memory 1830, a sensor module 1840, an input module 1850, a display 1860, an interface 1870, an audio module 1880, a camera module 1891, a power management module 1895, a battery 1896, an indicator 1897, or a motor 1898.

The AP 1810 may drive Operating System (OS) or an application program to control a plurality of hardware or software components connected to the AP 1810 and may perform processing and operations of various data including multimedia data. The AP 1810 may be implemented as System on Chip (SoC). According to an embodiment, the AP 1810 may further include a Graphic Processing Unit (GPU) (not shown).

The communication module 1820 (for example, the communication interface 160 of FIG. 1) may perform data transmission/reception for communication between the electronic device 1801 (for example, the electronic device 101) and other electronic devices (for example, the electronic device 104 or the server 106 of FIG. 1) through a network. According to an embodiment, the communication module 1820 may include at least one of a cellular module 1821, a WiFi module 1823, a BT module 1825, a GPS module 1827, a NFC module 1828, and a Radio Frequency (RF) module 1829.

The cellular module 1821 may provide a voice call, a video call, a message service, or an interne service through a communication network (for example, LTE, LTE-A, CDMA, WCDMA, UMTS, WiBro, or GSM). Also, the cellular module 1821 may identify and authenticate the electronic device 1801 in a communication network using a subscriber identification module (for example, the SIM card 1824). According to an embodiment, the cellular module 1821 may perform at least one part of functions that can be provided by the AP 1810. For example, the cellular module 1821 may perform at least one part of a multimedia control function.

The cellular module 1821 may include a Communication Processor (CP). Also, the cellular module 1821 may be implemented as SoC. In FIG. 18, components, such as the cellular module 1821 (for example, CP), the memory 1830, or the power management module 1895, are shown as separate components, however, the AP 1810 may be implemented to include at least one part (for example, the cellular module 1821) of the aforementioned components.

The AP 1810 or the cellular module 1821 may load a command or data received from at least one of a non-volatile memory or another component connected to the AP 1810 or the cellular module 1821 (for example, CP), in a volatile memory and then process the command or data. Also, the AP or the cellular module 1821 may store data received from or created by at least one of other components in a non-volatile memory.

The WiFi module 1823, the BT module 1825, the GPS module 1827, or the NFC module 1828 may include a processor to process data that is received or transmitted through the corresponding module. In FIG. 18, the WiFi module 1823, the BT module 1825, the GPS module 1827, or the NFC module 1828 are shown as separated blocks, however, at least one part (for example, two or more) of the WiFi module 1823, the BT module 1825, the GPS module 1827, or the NFC module 1828 may be included in a single Integrated Chip (IC) or a single IC package. For example, at least one part (for example, a communication processor corresponding to the cellular module 1821 and a WiFi processor corresponding to the WiFi module 1823) of processors corresponding to the WiFi module 1823, the BT module 1825, the GPS module 1827, or the NFC module 1828 may be implemented as single SoC.

The RF module 1829 may perform data transmission/reception, for example, transmission/reception of RF signals. The RF module 1829 may include a transceiver, a Power Amplifier Module (PAM), a frequency filter, or a Low Noise Amplifier (LNA). Also, the RF module 1829 may further include an element (for example, a conductor or a conducting wire) for transmitting/receiving electronic waves in free air space for wireless communication. In FIG. 18, the cellular module 1821, the WiFi module 1823, the BT module 1825, the GPS module 1827, or the NFC module 1828 are shown to share the RF module 1829, however, at least one of the cellular module 1821, the WiFi module 1823, the BT module 1825, the GPS module 1827, or the NFC module 1828 may perform transmission/reception of RF signals through a separate RF module.

The SIM card 1824 may be a card including a subscriber identification module, and may be inserted into a slot formed at a specific location of the electronic device. The SIM card 1824 may include unique identification information (for example, Integrated Circuit Card Identifier (ICCID)) or subscriber information (for example, International Mobile Subscriber Identity (IMSI)).

The memory 1830 (for example, the memory 130) may include an internal memory 1832 or an external memory 1834. The internal memory 1832 may include at least one of a volatile memory (for example, Random Access Memory (RAM), Dynamic RAM (DRAM), Static RAM (SRAM), Synchronous Dynamic RAM (SDRAM), or the like), or a non-volatile memory (for example, One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, or the like).

According to an embodiment, the internal memory 1832 may be a Solid State Drive (SSD). The external memory 1834 may further include a flash drive, for example, Compact Flash (CF), Secure Digital (SD), Micro Secure Digital (Micro-SD), Mini Secure Digital (Mini-SD), extreme Digital (xD), or Memory Stick. The external memory 1834 may be functionally connected to the electronic device 1801 through various interfaces. According to an embodiment, the electronic device 1801 may further include a storage device such as a hard drive.

The sensor module 1840 may measure the physical environment, sense an operation state of the electronic device 1801, and convert the measured or sensed information into electrical signals. The sensor module 1840 may include at least one of a gesture sensor 1840A, a gyro sensor 1840B, a pressure sensor 1840C, a magnetic sensor 1840D, an accelerometer 1840E, a grip sensor 1840F, a proximity sensor 1840G, a color sensor 1840H (for example, a RGB (Red, Green, Blue) sensor), a biometric sensor 1840I, a temperature/humidity sensor 1840J, an ambient light sensor 1840K, and an Ultra Violet (UV) sensor 1840M. Additionally or alternatively, the sensor module 1840 may include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), or a fingerprint sensor (not shown). The sensor module 1840 may further include a control circuit to control at least one sensor included therein.

The input device 1850 may include a touch panel 1852, a (digital) pen sensor 1854, a key 1856, or an ultrasonic input device 1858. The touch panel 1852 may be a capacitive type, a resistive type, an infrared type, or an ultrasonic type. Also, the touch panel 1852 may further include a controller (not shown). If the touch panel 1852 is a capacitive type, the touch panel 1852 can recognize proximity as well as a direct touch input. The touch panel 1852 may further include a tactile layer. In this case, the touch panel 1852 may give a user tactile impression.

The (digital) pen sensor 1854 may sense a pen touch input using a method that is the same as or similar to a method of receiving a touch input from a user. Also, the pen sensor 1854 may sense a pen touch input using a recognition sheet. The key 1856 may be a physical button, an optical key, or a keypad. The ultrasonic input device 1858 may be a device capable of detecting data by sensing sound waves with a microphone (for example, a microphone 1888) in the electronic device 1801, through an input tool of generating ultrasonic signals. The ultrasonic input device 1858 may enable RF IDentification (RFID). According to an embodiment, the electronic device 1801 may receive a user input from an external device (for example, a computer or a server) using the communication module 1820.

The display module 1860 (for example, the display 180 of FIG. 1) may include a panel 1862, a hologram device 1864, and a projector 1866. The panel 1862 may be a. Liquid-Crystal Display (LCD) or an Active-Matrix Organic Light-Emitting Diode (AM-OLED). The panel 1862 may be implemented to be flexible, transparent, or wearable. The panel 1862 may be integrated into the touch panel 1852. The hologram device 1864 may show a 3-Dimensional (3D) image in the air using interference of light. The projector 1866 may project light onto a screen to display an image. The screen may be located inside or outside the electronic device 1801. The display module 1860 may further include a control circuit for controlling the panel 1862, the hologram device 1864, and the projector 1866.

The interface 1870 may include, for example, High-Definition Multimedia Interface (HDMI) 1872, a Universal Serial Bus (USB) 1874, an optical interface 1876, and a D-subminiature (D-sub) 1878. The interface 1870 may be, for example, included in the communication interface 160 shown in FIG. 1. Additionally or alternatively, the interface 1870 may include, for example, a Mobile High-definition Link (MHL) interface, a Secure Digital (SD)/Multi-Media Card (MMC) interface, or an Infrared Data Association (IrDA) interface.

The audio module 1880 may convert sound into electronic signals and vice versa. At least one component of the audio module 1880 may be, for example included in the input/output interface 140 shown in FIG. 1. The audio module 1880 may convert voice information input/output through, for example, a speaker 1882, a receiver 1884, earphones 1886, or the microphone 1888, into electrical signals or vice versa.

The camera module 1891, which captures still images or moving images, may include one or more images sensors (for example, a front sensor or a rear sensor), lenses (not shown), an Image Signal Processor (ISP) (not shown), or a flash (for example, LED or xenon lamp) (not shown).

The power management module 1895 may manage power of the electronic device 1801. As not shown in FIG. 18, the power management module 1895 may include a Power Management Integrated Circuit (PMIC), a charge Integrated Circuit (IC), or a battery fuel gauge.

The PMIC may be installed in an integrated circuit or a SoC semiconductor. A charging method may be classified into a wired type and a wireless type. The charge IC may charge a battery and prevent inflow of overvoltage or overcurrent from a charger. According to an embodiment, the charge IC may include at least one of a wired charging method and a wireless charging method. The wireless charging method may be a magnetic resonance method, a magnetic induction method, or an electromagnetic wave method, and in order to perform the wireless charging method, the charge IC may include additional circuits, for example, a coil loop, a resonance circuit, and a rectifier.

The battery fuel gauge may measure, for example, a level of battery 1896, and a voltage, a current, and a temperature during charging. The battery 1896 may store or generate electricity, and may supply power to the electronic device 1801 using the stored or generated electricity. The battery 1896 may be a rechargeable battery or a solar battery.

The indicator 1897 may display a specific state (for example, a booting state, a message state, or battery level) of the electronic device 1801 or a part (for example, the AP 1810) of the electronic device 1801. The motor 1898 may convert electrical signals into mechanical vibration. Although not shown in FIG. 18, the electronic device 1801 may include a processor (for example, GPU) for supporting a mobile TV. The processor may process media data based on a standard of Digital Multimedia Broadcasting (DMB), Digital Video Broadcasting (DVB), media flow, or the like.

Each of the above-described units of the electronic device 1801 according to various embodiments of the present disclosure may be configured with one or more components, and the units may be termed according to a kind of the corresponding electronic device. The electronic device 1801 may include at least one of the above-described units. Also, the electronic device 1801 may omit some of the above-described units or further include another unit(s). Furthermore, some of the units of the electronic device 1801 may be combined to constitute entity which performs the same functions as the corresponding units.

The term “module” used in the present disclosure may means a unit including, for example, hardware, software, firmware, or a combination thereof. The “module” may be interchangeably used with another term, such as “unit”, “logic”, “logical block”, “component”, or “circuit”. The “module” may be a minimum unit or a part of components integrated into one body. Also, the “module” may be a minimum unit or a part for performing one or more functions. The “module” may be implemented mechanically or electronically. For example, the “module” may include at least one of an Application-Specific Integrated Circuit (ASIC) chip, Field-Programmable Gate Arrays (FPGAs), or a programmable-logic device, which performs certain operations, already developed or to be developed in future.

According to various embodiments, at least one part of an apparatus (for example, modules or their functions) or a method (for example, operations) according to various embodiments of the present disclosure may be implemented as an instruction stored in computer-readable storage media, for example, in the form of a programming module. When the instruction is executed by one or more processors (for example, the processor 120), the one or more processors may perform a function corresponding to the instruction. The computer-readable storage media may be, for example, the memory 130. At least one part of the programming module may be implemented (for example, executed) by the processor 120. At least one of the programming modules may include a module, a program, a routine, sets of instructions, or a processor for performing one or more functions.

The computer-readable storage media may include magnetic media (for example, a hard disk, a floppy disk, and a magnetic tape), optical media (for example, Compact Disc Read Only Memory (CD-ROM) and DVD), magneto-optical media (for example, a floptical disk), and hardware device (for example, Read Only Memory (ROM), and RAM, and flash memory) specifically configured to store and perform a program instruction (for example, a programming module). Also, the programming instruction may include a high-level language code that can be executed by a computer using an interpreter, as well as a machine code that is created by a compiler. The hardware device may be configured to operate as at least one software module for performing operations according to various embodiments of the present disclosure, and vice versa.

The module or the programming module according to various embodiments of the present disclosure may include at least one of the aforementioned components, omit a part of the aforementioned components, or further include another component. The module, the programming module, or operations that are performed by another component may be executed sequentially, in parallel, repeatedly, or heuristically. Also, a part of the operations may be executed in a different order, may be omitted, or may add another operation.

According to various embodiments of the present disclosure, in a storage medium that stores commands, the commands may be set to enable at least one processor to perform at least one operation when the instructions are executed by the at least one processor, wherein the at least one operation includes operations of: displaying a screen of a first application through a display of an electronic device; displaying a first portion for receiving a user input, in at least one area of the display; receiving a user input applied on or near the first portion; and displaying a second portion that is larger than the first portion, on the display, in response to the user input, wherein the second portion includes at least one of text, a symbol, or an icon for enabling a user to select at least one function of unique functions of the first application.

Therefore, according to various embodiments of the present disclosure, by providing a function related to an application through at least one of text, a symbol, or an icon when the application is executed on an electronic device, a user can use the function related to the application.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a touch-sensitive display; and
a processor configured to display a screen of a first application program on the display,
wherein the processor is configured to:
display a first portion that is able to receive a user input and is movable, on the display;
receive a user input that is applied on or near the first portion displayed on the display; and
display a second portion that is larger than the first portion, on the display, in response to the user input, and
wherein the second portion includes at least one item for enabling a user to select at least one function of the first application program.

2. The electronic device of claim 1, wherein the first portion includes at least one of text, a symbol, an image, or an icon.

3. The electronic device of claim 1, wherein the processor is further configured to receive a user input that is applied on or near the second portion and to execute at least one function of the first application program, in response to the user input.

4. The electronic device of claim 1, wherein the second portion includes a menu displayed in at least one area of the screen of the first application program, and the at least one item includes at least one of text, a symbol, an image, a moving image, or an icon.

5. The electronic device of claim 1, wherein the screen of the first application program is configured to include a first item for enabling a user to select at least one function of the first application program, the second portion displays a second item for enabling a user to select the same function as a function of the first item, and the second item is larger than the first item.

6. The electronic device of claim 1, wherein the first application program includes an application program including an input window, and the second portion includes an item for enabling a user to select a mode allowing an input to the input window.

7. The electronic device of claim 1, wherein the second portion further includes an item for enabling a user to select displaying one or more items that are different from one or more currently displayed items.

8. The electronic device of claim 1, wherein the second portion is configured to display a page of a plurality of pages each including at least one item, and the processor is configured to display a page of the plurality of pages in response to a user input.

9. The electronic device of claim 1, wherein the second portion further includes at least one item for enabling a user to select a function related to a system or a component of the electronic device.

10. The electronic device of claim 1, wherein the processor is further configured to:
display a screen of a second application program through the display;
display the first portion in at least one area of the display, while the screen of the second application program is displayed;
receive a user input that is applied on or near the first portion; and
display a third portion than is larger than the first portion, in response to the user input,
wherein the third portion includes at least one item for enabling a user to select at least one function of the second application program.

11. The electronic device of claim 10, wherein the third portion further include at least one item included in the second portion.

12. The electronic device of claim 11, wherein at least one of a shape, a color, or a size of the third portion is at least partially identical to or similar to at least one of a shape, a color, or a size of the second portion.

13. The electronic device of claim 1, wherein the processor is further configured to:
display a screen of a second application program, through the display of the electronic device, while the second portion is displayed; and
display at least one item for enabling a user to select at least one function of the second application program, in the second portion.

14. The electronic device of claim 1, wherein the processor is further configured to:
display at least one area of the screen of the first application program and at least one area of a screen of a second application program, at the same time, through the display;
receive a user input that is applied on or near the second portion; and
execute at least one function of the first application program and at least one function of the second application program, in response to the user input, to execute at least one function of the first application program or the second application program, in response to the user input, or to execute at least one function regardless of the first application program and the second application program, in response to the user input.

15. The electronic device of claim 1, wherein the processor is further configured to:
display an item related to an external electronic device connected in a wired or wireless fashion to the electronic device, in the second portion;
receive a user input that is applied on or near the item related to the external electronic device; and
transmit a signal to the external device using a communication interface of the electronic device, in response to the user input.

16. The electronic device of claim 1, wherein the processor is further configured to:
display a screen including one or more application program icons on the display of the electronic device;
display the first portion in at least one area of the display, while the screen is displayed;
receive a user input that is applied on or near the first portion; and
display a fourth portion on the display, that is larger than the first portion in response to the user input,
wherein the fourth portion includes at least one item for enabling a user to select at least one function of the electronic device.

17. A method comprising:
displaying a screen of a first application program on a touch-sensitive display of an electronic device;
receiving a user input that is applied on or near the first portion that is displayed on the display; and
displaying a second portion on the display that is larger than the first portion in response to the user input,
wherein the second portion includes at least one item for enabling a user to select at least one function of the first application program.

18. The method of claim 17, further comprising:
receiving a user input that is applied on or near the second portion; and
executing the at least one function of the first application program, in response to the user input.

19. The method of claim 17, wherein the second portion includes a menu displayed in at least one area of the screen of the first application program, and the at least one item includes at least one of text, a symbol, an image, a moving image, or an icon.

20. The method of claim 17, wherein the screen of the first application program includes a first item for enabling a user to select a function of the first application program, the second portion displays a second item for enabling a user to select the same function as a function of the first item, and the second item is larger than the first item.

21. The method of claim 17, further comprising:
displaying a screen of a second application program through the display;
displaying the first portion in at least one area of the display, while the screen of the second application program is displayed;
receiving a user input that is applied on or near the first portion; and
displaying a third portion on the display that is larger than the first portion in response to the user input,
wherein the third portion includes at least one item for enabling a user to select at least one function of the second application program.

22. The method of claim 21, wherein the third portion further includes at least one item of one or more items included in the second portion.

23. The method of claim 17, further comprising:
displaying a screen of a second application program through the display of the electronic device, while the second portion is displayed; and
displaying at least one item for enabling a user to select at least one function of the second application program, on the second portion.

24. The method of claim 17, further comprising:
displaying at least one area of the screen of the first application program and at least one area of a screen of a second application program, at the same time, on the display;
receiving a user input that is applied on or near the second portion; and
executing at least one function of the first application program and at least one function of the second application program, in response to the user input, executing at least one function of the first application program or the second application program, in response to the user input, or executing at least one function regardless of the first application program and the second application program, in response to the user input.

25. The method of claim 17, further comprising:
displaying an item related to an external electronic device that is connected in a wired or wireless manner to the electronic device, in the second portion;
receiving a user input that is applied on or near the item related to the external electronic device; and
transmitting a signal to the external device using a communication interface of the electronic device, in response to the user input.

26. The method of claim 17, further comprising:
displaying a screen including one or more application program icons on the display of the electronic device;
displaying the first portion in at least one area of the display, while the screen is displayed;
receiving a user input that is applied on or near the first portion; and
displaying a fourth portion on the display that is larger than the first portion in response to the user input, and
wherein the fourth portion includes at least one item for enabling a user to select at least one function of the electronic device.

27. An electronic device comprising:
a display;
a memory; and
a processor electrically connected to the display and the memory,
wherein the processor is configured to display a first screen on the display, to search for database including information about at least one function of a first application, in the memory, to display a portion including at least one item for enabling a user to select the at least one function, in at least one area of the display, based on at least one part of the information, to receive a user input that is applied on or near the portion, and to execute the at least one function of the first application, in response to the user input.

28. The electronic device of claim 27, wherein the information includes metadata related to at least one function of the first application, and wherein the metadata includes at least one among a total number of the at least one function, a number of the at least one function, a name of the at least one function, an image representing the at least one function, and a command or a string allocated to the at least one function.

29. The electronic device of claim 27, wherein the executing of the at least one function of the first application comprises:
searching for a command stored to correspond to the user input that is applied on or near the portion, in the database; and
notifying the found command to the first application.

30. The electronic device of claim 27, wherein the processor performs:
receiving a notification representing information about the least one function of the first application; and
storing the information about the at least one function of the first application in the database.
